(19) United States
(12) Patent Application Publication
(10) Pub. No.: US 2025/0390795 A1
(43) Pub. Date: Dec. 25, 2025

(54) SEMANTIC-RELATED LEARNING METHOD AND APPARATUS

(71) Applicants: Hon Hai Precision Industry Co., Ltd., New Taipei City (TW); FOXCONN TECHNOLOGY GROUP CO., LTD, Shenzhen (CN)

(72) Inventors: Yung-Hui Li, New Taipei City (TW); Kai-Lin Yang, New Taipei City (TW); Nien-Yi Jan, New Taipei City (TW); Yi-Rong Lin, New Taipei City (TW); Chengtai Cao, New Taipei City (TW); Xinhong Chen, New Taipei City (TW); Jianping Wang, New Taipei City (TW)

(73) Assignees: Hon Hai Precision Industry Co., Ltd., New Taipei City (TW); FOXCONN TECHNOLOGY GROUP CO., LTD, Shenzhen (CN)

(21) Appl. No.: 19/242,993

(22) Filed: Jun. 19, 2025

Related U.S. Application Data
(60) Provisional application No. 63/662,420, filed on Jun. 21, 2024.

(51) Int. Cl. G06N 20/00

(52) U.S. Cl. CPC G06N 20/00

(57) ABSTRACT

A semantic-related learning method and apparatus are provided. A captured image is encoded to generate a feature map. Multiple category information are encoded to generate multiple semantic embeddings. The feature map and the semantic embeddings are fused to generate a fused feature. The category information corresponding to the fused feature is predicted through a prediction model. The prediction model is trained based on a loss information between the predicted category information and a real information of the captured image.

### CROSS-REFERENCE TO RELATED APPLICATION

This application claims the priority benefit of U.S. provisional application Ser. No. 63/662,420, filed on Jun. 21, 2024. The entirety of the above-mentioned patent application is hereby incorporated by reference herein and made a part of this specification.

### BACKGROUND

### Technical Field

The disclosure relates to a machine learning technology, and more particularly to a semantic-related learning method and an apparatus.

### Description of Related Art

With the latest advances in deep learning (DL), significant progress has been made in the field of autonomous driving (AD). Although deep learning models are highly efficient, they typically operate as black-box neural networks and provide limited explainability. Various studies have emphasized this point and illustrated the impact of this disadvantage on public trust and regulation.

In explainable autonomous driving (EAD), a new multi-task and multi-label classification paradigm is introduced: the goal is not only to predict the upcoming driving behavior (for example, “stop”) but also to generate a set of reasonable explanations (for example, “red traffic light”). These explanations enhance the explainability of autonomous driving and thereby enhance public trust. For this purpose, various methods have been developed.

Although considerable progress has been made, current explainable autonomous driving methods still have two deficiencies:

The first deficiency is the insufficient use of semantic information inherent in actions and explanations. This rich semantics can guide the learning of more discriminative representations. For example, the explanation “solid line on the left” should guide the model to focus attention on the left detector in the lane markings, but this is a function often ignored by existing models.
The second deficiency is that current methods neglect the dynamic correlations among categories. These inter-category relationships are critical for avoiding inconsistencies among predicted categories and for identifying categories that may be overlooked by image feature extractors. For example, detecting a “red traffic light” should trigger the “stop” action and inherently suppress the “go forward” action, but may also require predicting the explanation “obstacle: person.”

### SUMMARY

The disclosure provides a semantic-related learning method and an apparatus to improve the explainability of deep learning.

In an embodiment of the disclosure, a semantic-related learning method is implemented through a processor and includes (but is not limited to) the following steps. A captured image is encoded to generate a feature map. The captured image is an image obtained by shooting a scene. A plurality of category information are encoded to generate a plurality of semantic embeddings. The category information corresponds to a textual content. The feature map and one of the plurality of semantic embeddings are fused to generate a fused feature. At least one of the plurality of category information corresponding to the fused feature is predicted through a prediction model. The prediction model is trained according to a loss information between the predicted category information and a real information of the captured image.

In an embodiment of the disclosure, a semantic-related learning apparatus includes (but is not limited to) a storage and a processor. The storage is configured to store a code. The processor is coupled to the storage. The processor is disposed to load the code so as to execute the following steps. A captured image is encoded to generate a feature map. The captured image is an image obtained by shooting a scene. A plurality of category information are encoded to generate a plurality of semantic embeddings. The category information corresponds to a textual content. The feature map and one of the plurality of semantic embeddings are fused to generate a fused feature. At least one of the plurality of category information corresponding to the fused feature is predicted through a prediction model. The prediction model is trained according to a loss information between the predicted category information and a real information of the captured image.

Based on the above, in the embodiment of the disclosure, the semantic-related learning method and the apparatus fuse a feature representation (i.e., the feature map) obtained by encoding the captured image and a feature representation (i.e., the semantic embedding) obtained by encoding the category information. The fused feature is used to predict the category information corresponding to the captured image, and parameters of the prediction model are updated accordingly. Thus, a category-specific representation is learned using semantics in the category information, and the interaction thereof is modeled to improve model performance.

To make the features and advantages of the disclosure more comprehensible, several embodiments accompanied with drawings are described in detail as follows.

### BRIEF DESCRIPTION OF THE DRAWINGS

FIG. 1 is a block diagram of elements of a semantic-related learning apparatus according to an embodiment of the disclosure.

FIG. 2 is a flowchart of a semantic-related learning method according to an embodiment of the disclosure.

FIG. 3 is a schematic diagram of a prediction model according to an embodiment of the disclosure.

FIG. 4 is a schematic diagram of an encoder according to an embodiment of the disclosure.

FIG. 5 is a schematic diagram of a semantic-guided learner according to an embodiment of the disclosure.

FIG. 6 is a flowchart of semantic-guided learning according to an embodiment of the disclosure.

FIG. 7 is a schematic diagram of a dynamic correlation learner according to an embodiment of the disclosure.

FIG. 8 is a flowchart of dynamic correlation learning according to an embodiment of the disclosure.

FIG. 9 is a schematic diagram of a classifier according to an embodiment of the disclosure.

FIG. 10A is a schematic diagram of a prediction result of prior art.

FIG. 10B is a schematic diagram of a prediction result according to an embodiment of the disclosure.

FIG. 11A is a schematic diagram of a prediction result of prior art.

FIG. 11B is a schematic diagram of a prediction result according to an embodiment of the disclosure.

FIG. 12A is a schematic diagram illustrating an attention region for left-related category information according to an embodiment of the disclosure.

FIG. 12B is a schematic diagram illustrating an attention region for right-related category information according to an embodiment of the disclosure.

FIG. 13A is a schematic diagram illustrating an attention region for left-related category information according to an embodiment of the disclosure.

FIG. 13B is a schematic diagram illustrating an attention region for right-related category information according to an embodiment of the disclosure.

### DESCRIPTION OF THE EMBODIMENTS

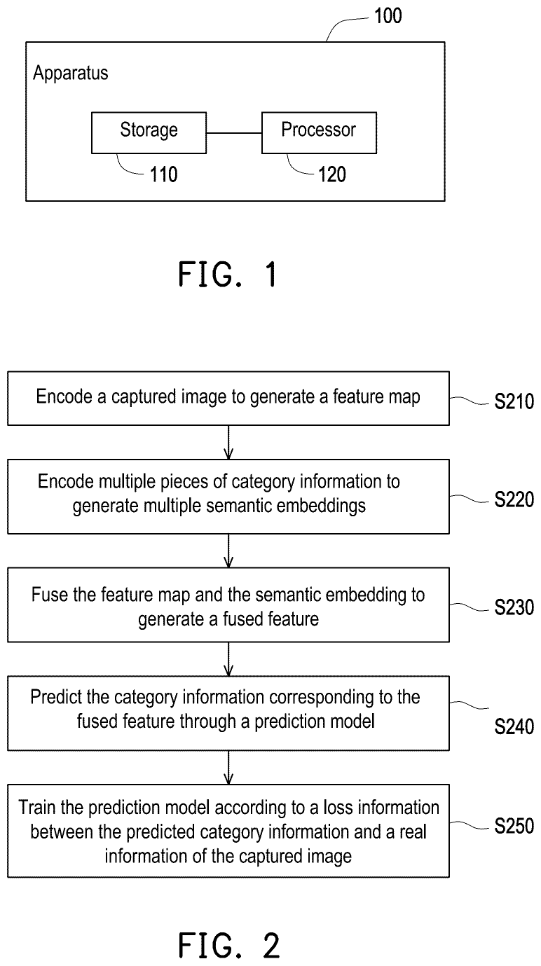

FIG. 1 is a block diagram of elements of a semantic-related learning apparatus according to an embodiment of the disclosure. Referring to FIG. 1, an apparatus 100 includes a storage 110 and a processor 120, but is not limited thereto. The apparatus 100 may be a mobile phone, a tablet computer, a notebook computer, a desktop computer, a server, a voice assistant device, a smart home appliance, a wearable device, an in-vehicle system, or another electronic device.

The storage 110 may be any type of fixed or removable random access memory (RAM), read only memory (ROM), flash memory, hard disk drive (HDD), solid-state drive (SSD), or a similar element. In an embodiment, the storage 110 is used to store a code, a software module, a configuration, data (for example, parameters of a model, a dataset, a sample, a feature, or a prediction), or a file, and further details thereof will be provided in subsequent embodiments.

The processor 120 is coupled to the storage 110. The processor 120 may be a central processing unit (CPU), a graphic processing unit (GPU), or another programmable general-purpose or special-purpose microprocessor, a digital signal processor (DSP), a programmable controller, a field programmable gate array (FPGA), an application-specific integrated circuit (ASIC), a neural processing unit (NPU), a tensor processing unit (TPU), an artificial intelligence (AI) accelerator, a neural engine, or a similar element or a combination of the above elements. In an embodiment, the processor 120 is configured to execute all or part of operations of the apparatus 100, and is capable of loading and executing each code, software module, file, and data stored in the storage 110.

In some embodiments, the apparatus 100 further includes an image capturing device (not shown in the figure). The image capturing device is, for example, a camera, a camcorder, a dashcam, a camera module, or another device or circuit having an image capturing function. In an embodiment, the processor 120 obtains a captured image from the image capturing device. For example, the captured image is transmitted through a wired or wireless communication connection. The captured image is an image obtained by the image capturing device by shooting a scene. The scene may be a road, a factory, an office, or another site, but can still be adjusted according to actual needs, and the embodiments of the disclosure do not limit the type thereof.

Hereinafter, the method described in the embodiment of the disclosure will be explained in conjunction with each device, element, and module in the apparatus 100. Each step of the method may be adjusted according to the implementation condition and is not limited thereto.

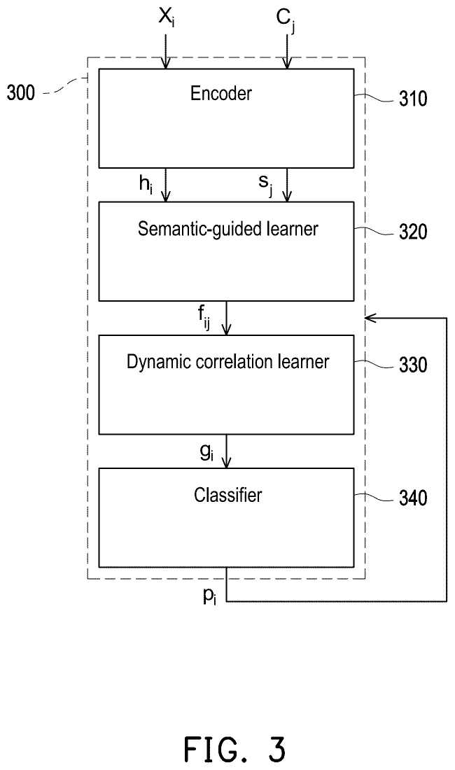

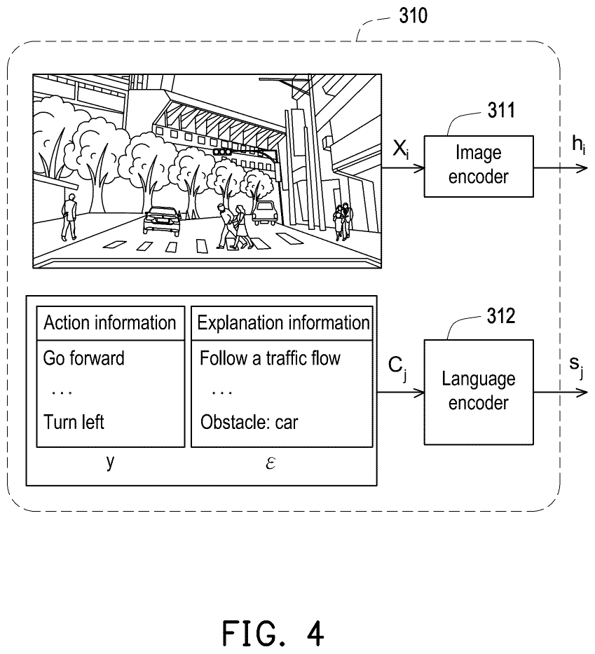

FIG. 2 is a flowchart of a semantic-related learning method according to an embodiment of the disclosure. Referring to FIG. 2, a captured image is encoded by the processor 120 to generate a feature map (step S210). Specifically, FIG. 3 is a schematic diagram of a prediction model 300 according to an embodiment of the disclosure, and FIG. 4 is a schematic diagram of an encoder according to an embodiment of the disclosure. Referring to FIGS. 3 and 4, the prediction model 300 includes an encoder 310. One of the functions of the encoder 310 is to perform feature encoding or extract features from input data (for example, a captured image). An input of the encoder 310 includes a captured image Xᵢ (for example, i is a positive integer and represents a number or a sequence). The encoder 310 includes an image encoder 311. The captured image Xᵢ is encoded by the processor 120 through the image encoder 310 to generate a feature map hᵢ. The image encoder 310 may be any version of DeepLab, a convolutional network for biomedical image segmentation (U-Net), a pyramid scene parsing network (PSPNet), an exploiting encoder representations for efficient semantic segmentation (LinkNet), or a lite reduced atrous spatial pyramid pooling (LRASPP).

Referring to FIG. 2, a plurality of category information are encoded by the processor 120 to generate a plurality of semantic embeddings (step S220). Specifically, any one or each of the category information corresponds to a textual content. Taking an autonomous driving application as an example, the textual content of the category information may be go forward, turn left or right, stop, obstacle, follow a traffic flow, or green light on. In an embodiment, referring to FIG. 4, a category information Cⱼ (for example, j is a positive integer and represents a number or a sequence) includes an action information y and an explanation information ε. A scene corresponding to the captured image is a road. The explanation information ε is for describing a condition of the road presented by the captured image Xᵢ, and the action information y is for describing a vehicle control command corresponding to the condition. For example, the textual content of the explanation information ε may be red light being on or obstacle, and the action information y may be going forward or turning left or right. However, according to different needs and application scenarios, the types of the category information may be correspondingly changed, and the embodiments of the disclosure do not limit the type thereof.

Referring to FIG. 4, an input of the encoder 310 further includes the category information Cⱼ. The encoder 310 further includes a language encoder 312. The category information Cⱼ is encoded by the processor 120 through the language encoder 312 to generate a semantic embedding Sⱼ. The language encoder 312 may be a sentence-bidirectional encoder representations from transformers (SBERT), a universal sentence encoder (USE), a supervised learning of universal sentence representations from natural language inference data (InferSent), or a simple contrastive learning of sentence embeddings (SimCSE). Semantic embedding is a technique for mapping words, sentences, or text/content in natural language into a vector space, so that the generated vector or other feature representation can capture semantic information of the text. Assuming there are a plurality of category information, the language encoder 312 encodes each of the category information respectively and generates a corresponding semantic embedding.

Referring to FIG. 2, the feature map and the semantic embedding are fused by the processor 120 to generate a fused feature (step S230). Specifically, referring to FIG. 3, the prediction model 300 further includes a semantic-guided learner 320. Input data of the semantic-guided learner 320 is output data of the encoder 310 (for example, the feature map hᵢ and the semantic embedding Sⱼ).

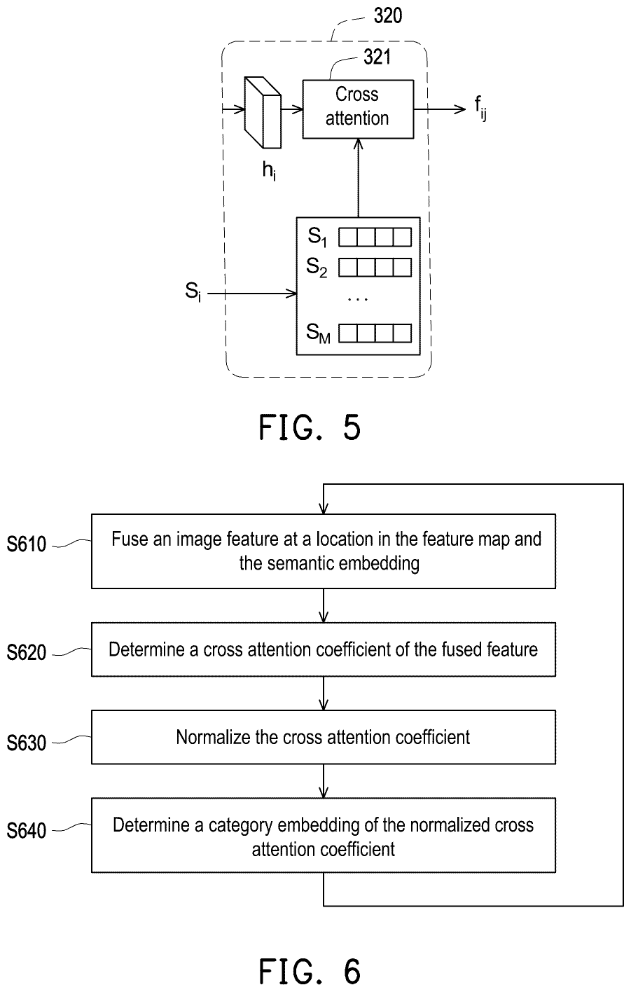

FIG. 5 is a schematic diagram of the semantic-guided learner 320 according to an embodiment of the disclosure. Referring to FIG. 5, assuming there are M category information (with M being a positive integer), the M semantic embeddings S₁, S₂, . . . , S_{M} (that is, j is one of 1 to M) are input. The feature map hᵢ and the semantic embedding Sⱼ are subjected to a cross attention 321 by the semantic-guided learner 320.

FIG. 6 is a flowchart of semantic-guided learning according to an embodiment of the disclosure. Referring to FIG. 6, the semantic embedding Sⱼ includes a first semantic embedding S₁. An image feature at each location in the feature map hᵢ is fused with the first semantic embedding S₁ by the processor 120 to generate a fused feature corresponding to each location in the feature map hᵢ and the first semantic embedding S₁ (step S610). A location in the feature map hᵢ may be a pixel location or a location in another coordinate system. For example, a pixel location (w, h) is the wth pixel on a horizontal axis and the hth pixel on a vertical axis, where w and h are positive integers. Similarly, for other semantic embeddings (for example, a second semantic embedding S₂ or an Mth semantic embedding S_{M}), a fused feature corresponding to each location in the feature map hᵢ and the other semantic embedding is generated by the processor 120.

In an embodiment, an image feature and the first semantic embedding are fused by the processor 120 through a tanh function. For example,

$${h}_{i , j}^{w , h} = tanh ( {w}_{1} {h}_{i}^{w , h} ⊙ {w}_{2} {s}_{j} ) \qquad ( 1 )$$

where

$${h}_{i , j}^{w , h}$$

is a fused feature of an image feature at a location (w, h) in the feature map hᵢ and a jth semantic embedding sⱼ, w₁ is a weight corresponding to the feature map hᵢ,

$${h}_{i}^{w , h}$$

is an image feature at the location (w, h) in the feature map hᵢ, w₂ is a weight corresponding to the semantic embedding, and sⱼ is the jth semantic embedding.

In other embodiments, the image feature and the semantic embedding may be fused by the processor 120 through a function. For example, the image feature and the semantic embedding may be concatenated, added after being mapped to a same dimension, averaged after being mapped to a same dimension, or a maximum value may be taken after being mapped to a same dimension.

Referring to FIGS. 5 and 6, in the cross attention 321, a cross attention coefficient of the fused feature is determined by the processor 120 (step S620). In an embodiment, the category information includes an information corresponding to a first category. The category information may correspond to a plurality of categories, and the first category is one of the categories, and “first” may have no ordinal meaning. A weight corresponding to the information corresponding to the first category is assigned by the processor 120 to the fused feature, and the weight is related to an attention degree of the information corresponding to the first category. The cross attention coefficient is an attention score, which indicates an importance of a category information corresponding to a certain category at a certain location in the feature map. For example,

$${\tilde{α}}_{i , j}^{w , h} = {w}_{3} {h}_{i , j}^{w , h} \qquad ( 2 )$$

where

$${\tilde{α}}_{i , j}^{w , h}$$

is a cross attention coefficient of an image feature at a location (w, h) in the feature map hᵢ with respect to the jth semantic embedding Sⱼ, and w₃ is a weight assigned to the fused feature

$${h}_{i , j}^{w , h}$$

corresponding to the information corresponding to the jth category.

In an embodiment, the plurality of category information include an information corresponding to a second category. A feature corresponding to the information corresponding to the second category may be extracted by the processor 120 from the fused feature at one or more locations in the feature map to generate a category embedding corresponding to the second category. The category information may correspond to a plurality of categories, and the second category is one of the categories (and may also be the first category), and “second” may have no ordinal meaning.

More specifically, referring to FIG. 6, the cross attention coefficient may be normalized by the processor 120 (step S630). For example,

$${α}_{i , j}^{w , h} = \frac{exp ( {\tilde{α}}_{i , j}^{w , h} )}{{\sum }_{{w}^{′} = 1}^{W} {\sum }_{{h}^{′} = 1}^{H} exp ( {\tilde{α}}_{i , j}^{{w}^{′} {h}^{′}} )} \qquad ( 3 )$$

where

$${α}_{i , j}^{w , h}$$

is a normalized cross attention coefficient of an image feature at a location (w, h) in the feature map hᵢ with respect to the jth semantic embedding sⱼ, exp( ) is an exponential function, and

$${\tilde{α}}_{i , j}^{{w}^{′} {h}^{′}}$$

is a cross attention coefficient of an image feature at a location (w′, h′) in the feature map hᵢ with respect to the jth semantic embedding sⱼ.

The category embedding may be determined by the processor 120 according to the normalized cross attention coefficient (step S640). In an embodiment, the normalized cross attention coefficient may be used by the processor 120 as a weight, and a weighted operation may be performed on the fused features at all locations in the feature map. For example,

$${f}_{l , j} = {\sum }_{w = 1}^{W} {\sum }_{h = 1}^{H} {α}_{i , j}^{w , h} {h}_{i , j}^{w , h} \qquad ( 4 )$$

where f_{i,j} is a feature extracted from the feature map hᵢ by the jth category information (that is, a category embedding corresponding to the jth category), W is a positive integer and a total number of positions along one axis of the feature map hᵢ, and H is a positive integer and a total number of positions along another axis of the feature map hᵢ.

Similarly, steps S610 to S640 may be repeatedly executed by the processor 120 to obtain category embeddings corresponding to other categories or other category information. For example, category embeddings corresponding to a second category to an Mth category are obtained for the second semantic embedding S₂ to the Mth semantic embedding S_{M} in FIG. 5.

Thus, the semantic-guided learner 320 allows each category information to focus on a scene region semantically related thereto (that is, an image region in the captured image). For example, left-related category information focuses on important information in a left part of the captured image, and right-related category information focuses on important information in a right part of the captured image.

Referring to FIG. 2, one or more category information corresponding to the fused feature is predicted by the processor 120 through the prediction model 300 (step S240). Specifically, the fused feature may be the fused feature generated in step S610 as described above, or may be the category embedding generated in step S640 as described above (which enhances an importance or an attention degree of specific category information compared to the fused feature of step S610).

Referring to FIG. 3, the prediction model 300 further includes a dynamic correlation learner 330. Input data of the dynamic correlation learner 330 is output data of the semantic-guided learner 320 (for example, a category embedding f_{i,j}). For example, for the ith captured image Xᵢ, a combination Fᵢ of category embeddings thereof includes a category embedding f₁ corresponding to a first category (that is, a category embedding f_{i,1}), a category embedding f₂ corresponding to a second category (that is, a category embedding f_{i,2}), . . . , and a category embedding f_{M} corresponding to an Mth category (that is, a category embedding f_{i,M}).

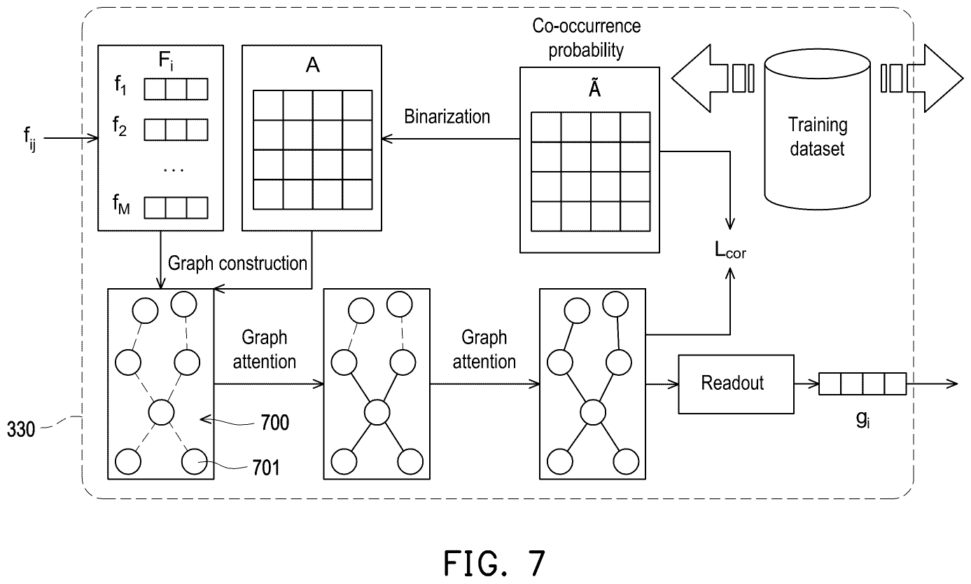

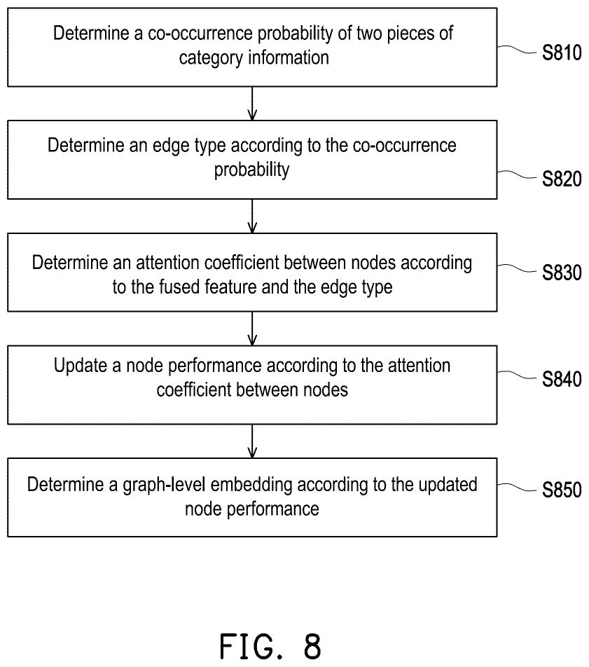

FIG. 7 is a schematic diagram of the dynamic correlation learner 330 according to an embodiment of the disclosure, and FIG. 8 is a flowchart of dynamic correlation learning according to an embodiment of the disclosure. Referring to FIGS. 7 and 8, a co-occurrence probability Ã of two category information is determined by the processor 120 (step S810). If the two category information appear together in the same sample more frequently across multiple samples, it may indicate a higher correlation between the two category information. Conversely, if the two category information appear together in the same sample less frequently across multiple samples, it may indicate a lower correlation between the two category information. The co-occurrence probability corresponds to a number of times the two category information appear together in the same sample across multiple samples, and may also be referred to as a co-occurrence frequency.

In an embodiment, the plurality of category information include an information corresponding to a third category and an information corresponding to a fourth category. The category information may correspond to a plurality of categories, and the third category and the fourth category are respectively one of the categories (and may also be the first category or second category), and “third” and “fourth” may have no ordinal meaning. An attention coefficient between a category embedding corresponding to the third category and a category embedding corresponding to the fourth category may be determined by the processor 120. The attention coefficient between the two category embeddings represents a correlation between the two category embeddings.

In an embodiment, a co-occurrence probability Ã of two category information of the third category and the fourth category may be determined by the processor 120 from a training dataset. The training dataset includes a plurality of training samples (for example, images of specific scenes), and each of the training samples is labeled with one or more corresponding category information. The co-occurrence probability Ã is a ratio of a number of times the two category information appear together to a number of times one of the category information appears across the plurality of training samples in the training dataset. For example,

$${\tilde{A}}_{j , k} = {T}_{j , k} / {T}_{j} \qquad ( 5 )$$

where Ã_{j,k} is a co-occurrence probability of the jth category information (for example, category information of the third category) with respect to the kth category information (for example, category information of the fourth category), T_{j,k} is a number of times the two category information appear together in the same training sample across the plurality of training samples in the training dataset, and Tⱼ is a number of training samples in which the jth category information appears in the training dataset.

The edge type may be determined by the processor 120 according to the co-occurrence probability (step S820). Specifically, in a graph neural network (GNN) 700, a feature representation (for example, a category embedding) is used by the processor 120 as a node 701. A connection between two nodes 701 may be defined as an edge. The edge type is used to indicate a directionality corresponding to the two category information, and the directionality is that one of the two category information serves as a start node and the other of the two category information serves as an end node.

In an embodiment, the co-occurrence probability may be binarized by the processor 120. For example, in response to the co-occurrence probability being greater than a preset threshold (for example, 0.3, 0.6, or 0.8, but not limited thereto), the co-occurrence probability is set to a maximum value (for example, 1) by the processor 120. In response to the co-occurrence probability not being greater than the preset threshold, the co-occurrence probability is set to a minimum value (for example, 0) by the processor 120.

Next, an edge type r_{j,k} is defined for a binarized co-occurrence probability A. For example,

$${r}_{j , k} = \{ \begin{matrix}\begin{matrix}\begin{matrix}[ 0 , 0 ] , if {c}_{j} ∈ y and {c}_{k} ∈ y \\ [ 0 , 1 ] , if {c}_{j} ∈ y and {c}_{k} ∈ ε\end{matrix} \\ [ 1 , 0 ] , if {c}_{j} ∈ ε and {c}_{k} ∈ y\end{matrix} \\ [ 1 , 1 ] , if {c}_{j} ∈ ε and {c}_{k} ∈ ε\end{matrix} . \qquad ( 6 )$$

Taking the category information as action information y and explanation information ε as an example, there are four directional edge types. Binary indicators are used to define the edge types. If the start node is action information y and the end node is another action information y, then the edge type r_{j,k}=[0, 0]; if the start node is action information y and the end node is explanation information ε, then the edge type r_{j,k}=[0, 1]; if the start node is explanation information ε and the end node is action information y, then the edge type r_{j,k}=[1, 0]; if the start node is explanation information ε and the end node is another explanation information ε, then the edge type r_{j,k}=[1, 1].

Referring to FIG. 8, an attention coefficient (also referred to as an edge attention score) between two nodes (that is, two category embeddings or two node representations) may be determined by the processor 120 according to the edge type (step S830) (as shown as “graph attention” in FIG. 7). Taking the two nodes as the third category and the fourth category as an example, an attention coefficient between the third category and the fourth category may be determined by the processor 120 according to the edge type. For example, the attention coefficient is calculated and normalized as follows:

$${β}_{i , j , k} = \frac{exp ( L R e L U ( {W}_{6} [ {w}_{4} {f}_{i , j} ‖ {w}_{4} {f}_{i , k} ‖ {w}_{5} {r}_{j , k} ] ) )}{{\sum }_{k ∈ {N}_{i}} exp ( L R e L U ( {W}_{6} [ {w}_{4} {f}_{i , j} ‖ {w}_{4} {f}_{i , k} ‖ {w}_{5} {r}_{j , k} ] ) )} \qquad ( 7 )$$

where β_{i,j,k} is an attention coefficient between a category embedding f_{i,j} of the jth category (for example, the third category) and a category embedding f_{i,k} of the kth category (for example, the fourth category) in the feature map hᵢ, LReLU( ) is a leaky rectified linear unit (LReLU) function, w₄ is a weight assigned to the category embeddings f_{i,j} and f_{i,k} of the jth category and the kth category, w₅ is a weight assigned to the edge type r_{j,k}, W₆ is a weight, and Nᵢ is a node i itself and first-order neighbors of the node i, that is, directly adjacent nodes.

Next, the category embedding corresponding to the third category (that is, the node/feature representation) is updated by the processor 120 according to the attention coefficient between nodes (step S840). For example, the processor 120 determines a new category embedding corresponding to the third category using the (normalized) attention coefficient and the category embedding of the fourth category:

$${f}_{i , j}^{1} = E LU ( {\sum }_{k ∈ {N}_{i}} {β}_{i , j , k} {w}_{4} {f}_{i , k} ) \qquad ( 8 )$$

where

$${f}_{i , j}^{1}$$

is a new category embedding of the jth category (for example, the third category) after a first round of iteration, and ELU( ) is an exponential linear unit (ELU).

After L iterations, new category embeddings for the first category to the Mth category are obtained:

$${\{ {f}_{i , j}^{L} \}}_{j = 1}^{M} \qquad ( 9 )$$

Next, a graph-level embedding is determined by the processor 120 according to the updated node representations (that is, the new category embeddings) (step S850) (for example, “readout” as shown in FIG. 7). In an embodiment, the processor 120 may concatenate the category embeddings corresponding to the plurality of category information. For example,

$${g}_{i} = {w}_{7} ( ‖ {\{ {f}_{i , j}^{L} \}}_{j = 1}^{M} ) \qquad ( 10 )$$

where gᵢ is the concatenated category embedding (that is, the graph-level embedding), and ∥ is a concatenation operation.

Thus, the dynamic correlation learner 330 can actively capture correlations among the plurality of category information. For example, in a captured image, if the predicted action information is “stop,” then the explanation information is “obstacle: person” and “red light on.” That is, the dynamic correlation learner 330 enhances the correlation among the “stop” node, the “obstacle: person” node, and the “red light on” node.

Referring to FIG. 3, the prediction model 300 further includes a classifier 340. Input data of the classifier 340 is output data of the dynamic correlation learner 330 (for example, a concatenated category embedding gᵢ). The classifier 340 can predict one or more category information Pi corresponding to the concatenated category embedding gᵢ.

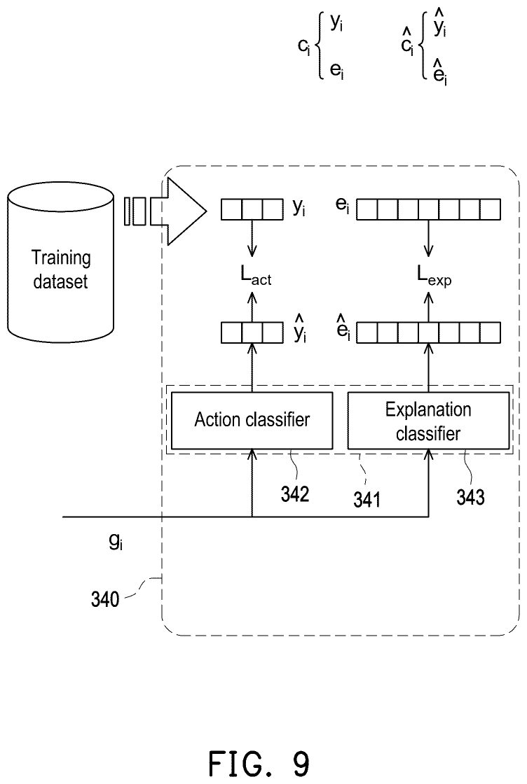

More specifically, FIG. 9 is a schematic diagram of the classifier 340 according to an embodiment of the disclosure. Referring to FIG. 9, the classifier 340 includes a classifier head pair 341. The classifier head pair 341 includes an action classifier 342 for predicting action information and an explanation classifier 343 for predicting explanation information. For example,

$${\hat{y}}_{i} = Sigmoid ( {W}_{8} {g}_{i} ) \qquad ( 11 )$$

$${\hat{ϵ}}_{i} = Sigmoid ( {W}_{9} {g}_{i} ) \qquad ( 12 )$$

where ŷᵢ is the predicted action information, Sigmoid( ) is a sigmoid function, W₈ and W₉ are weights, and \hat{ϵ}ᵢ is the predicted explanation information. That is, the predicted category information ĉᵢ includes a predicted action information ŷᵢ and the predicted explanation information \hat{ϵ}ᵢ.

Referring to FIG. 2, the prediction model 300 is trained by the processor 120 according to a loss information between the predicted category information and a real information of the captured image (step S250). In an embodiment, the loss information includes a loss function. The prediction model may be trained by the processor 120 through the loss function. The loss function includes a first error and a second error. The first error is an error between the predicted category information and the real information, and the second error is an error between the attention coefficient and the co-occurrence probability. For example, the first error is defined by binary cross entropy losses:

$$L = {L}_{act} + λ {L}_{exp} + η {L}_{c o r} \qquad ( 13 )$$

where L is the loss function, L_{act} is an error between the predicted action information ŷᵢ and a real information yᵢ corresponding to the action information, Lₑₓₚ is an error between the predicted explanation information εᵢ and a real information εᵢ corresponding to the explanation information, y and η are coefficients, and L_{cor} is a second error related to the co-occurrence probability. A real information Cᵢ includes the real information yᵢ and the real information εᵢ.

In an embodiment, referring to FIG. 7, the second error is a mean square error related to a (normalized) attention coefficient β_{i,j,k} and the co-occurrence probability Ã_{j,k}:

$${L}_{c o r} = \frac{{\sum }_{i = 1}^{N} {\sum }_{j = 1}^{M} {\sum }_{k = 1}^{M} {( {β}_{i , j , k} - {\tilde{A}}_{j , k} )}^{2}}{{M}^{2} N} \qquad ( 14 )$$

where N is a positive integer and a total number of captured images in the training dataset, and M is a positive integer and a total number of category information in the training dataset.

In an embodiment, during a training phase of the prediction model, parameters of the prediction model are recursively updated by minimizing the loss function. For example, a back-propagation method. The parameters of the model include, for example, weights, number of layers, positions or number of neurons, activation functions, or offsets, but are not limited thereto. Methods for updating parameters include, for example, gradient descent, Adaptive Moment Estimation (Adam) optimizer, momentum method, Adagrad, or conjugate gradient method, but are not limited thereto. That is, one of the multiple objectives of the training phase is to make the predicted category information output by the prediction model approximate or equal to corresponding real information/labels. In an embodiment, the trained prediction model refers to a prediction model whose loss function has converged, prediction accuracy has reached a corresponding threshold, or training has met an early stopping criterion, but the criterion for completed training may still be adjusted according to other tasks or requirements.

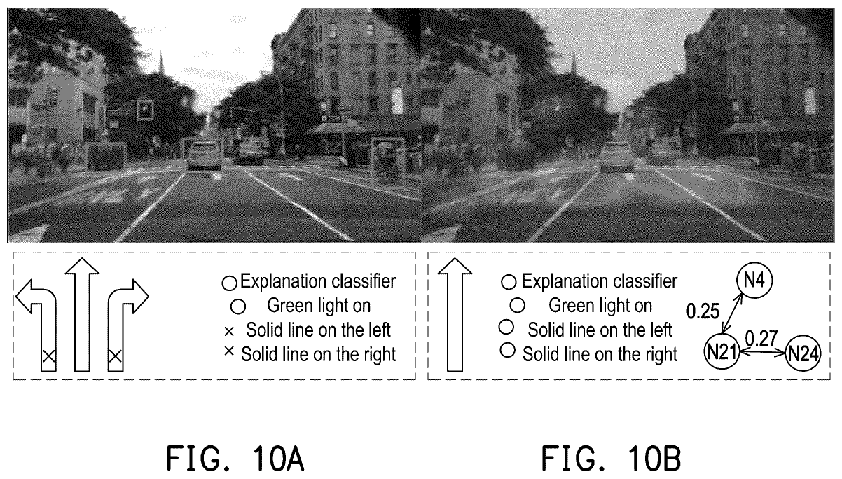

FIG. 10A is a schematic diagram of a prediction result of prior art. Referring to FIG. 10A, only an action information “follow a traffic flow” and an explanation information “green light on” can be obtained. FIG. 10B is a schematic diagram of a prediction result according to an embodiment of the disclosure. Referring to FIG. 10B, in addition to the action information “follow a traffic flow” and the explanation information “green light on,” explanation information “solid line on the left” and “solid line on the right” are also obtained. It is notable that in a graph neural network, a correlation between a node N4 corresponding to “follow a traffic flow” and a node N21 corresponding to “solid line on the left” and a correlation between the node N21 corresponding to “solid line on the left” and a node N24 corresponding to “solid line on the right” can be enhanced.

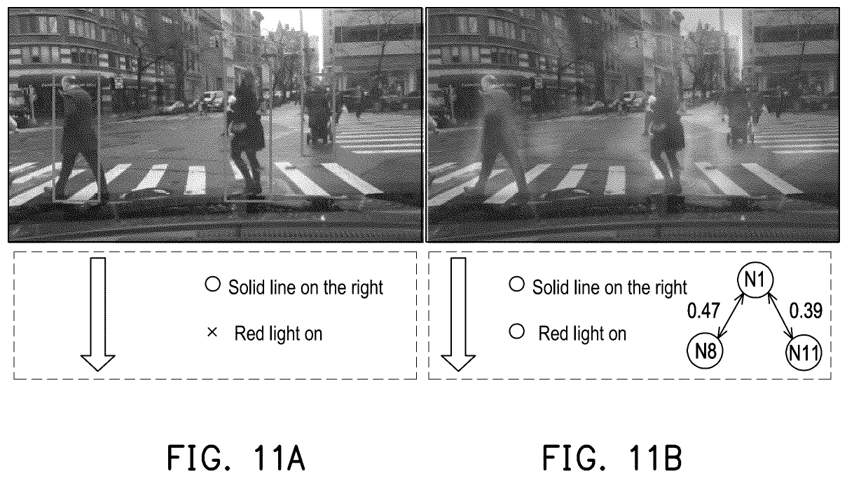

FIG. 11A is a schematic diagram of a prediction result of prior art. Referring to FIG. 11A, only an explanation information “obstacle: person” can be obtained. FIG. 11B is a schematic diagram of a prediction result according to an embodiment of the disclosure. Referring to FIG. 11B, in addition to the explanation information “obstacle: person,” an explanation information “red light on” is also obtained. It is notable that in a graph neural network, a correlation between a node N1 corresponding to “stop” and a node N8 corresponding to “obstacle: person,” and a correlation between the node N1 corresponding to “stop” and a node N11 corresponding to “red light on” can be enhanced.

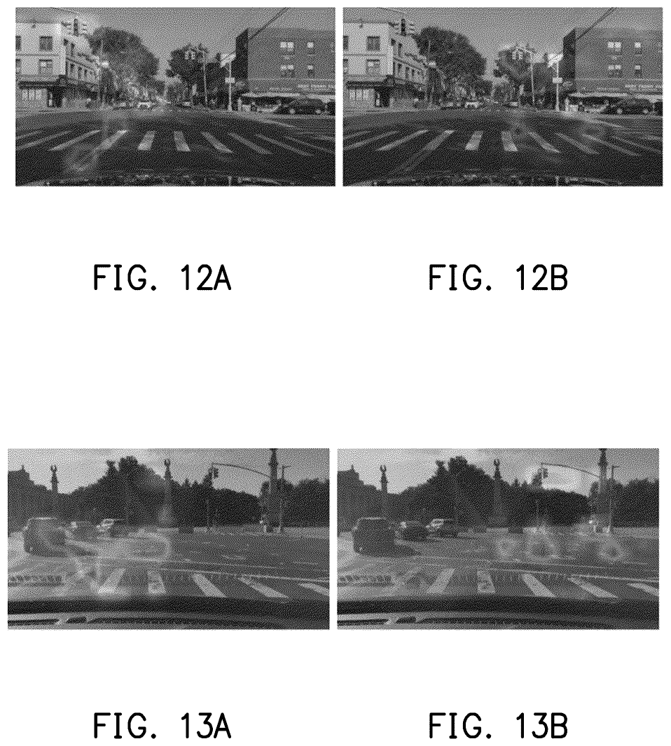

FIG. 12A is a schematic diagram illustrating an attention region for left-related category information according to an embodiment of the disclosure, and FIG. 12B is a schematic diagram illustrating an attention region for right-related category information according to an embodiment of the disclosure. FIG. 12A focuses only on a left half of the image, and FIG. 12B focuses only on a right half of the image.

FIG. 13A is a schematic diagram illustrating an attention region for left-related category information according to an embodiment of the disclosure, and FIG. 13B is a schematic diagram illustrating an attention region for right-related category information according to an embodiment of the disclosure. FIG. 13A focuses only on a left half of the image, and FIG. 13B focuses only on a right half of the image.

In some application scenarios, even if some functions or conditions are not executed (for example, the loss function ignores the second error, category embeddings of node level are directly read out, or a graph neural network assigns the same attention degree), a certain level of prediction accuracy may still be achieved.

In summary, in the semantic-related learning method and apparatus of the embodiment of the disclosure, features of each category information are improved through feature fusion, correlations among category information are analyzed through a graph neural network, and a novel loss information is proposed. Thus, explainability of deep learning can be improved, and more contextually appropriate category information can be provided.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A semantic-related learning method, implemented through a processor, the semantic-related learning method comprising:
encoding a captured image to generate a feature map, wherein the captured image is an image obtained by shooting a scene;
encoding a plurality of category information to generate a plurality of semantic embeddings, wherein one of the plurality of category information corresponds to a textual content;
fusing the feature map and one of the plurality of semantic embeddings to generate a fused feature;
predicting at least one of the plurality of category information corresponding to the fused feature through a prediction model; and
training the prediction model according to a loss information between the predicted category information and a real information of the captured image.

2. The semantic-related learning method according to claim 1, wherein the plurality of semantic embeddings comprise a first semantic embedding, and fusing the feature map and one of the plurality of semantic embeddings comprises:
fusing an image feature at each location in the feature map and the first semantic embedding to generate a fused feature corresponding to each location in the feature map and the first semantic embedding.

3. The semantic-related learning method according to claim 2, wherein fusing the image feature at each location in the feature map and the first semantic embedding comprises:
fusing the image feature and the first semantic embedding through a tanh function.

4. The semantic-related learning method according to claim 1, wherein the plurality of category information comprise an information corresponding to a first category, and the learning method further comprises:
determining a cross attention coefficient of the fused feature, comprising:
assigning a weight corresponding to the information corresponding to the first category to the fused feature, wherein the weight is related to an attention degree of the information corresponding to the first category.

5. The semantic-related learning method according to claim 1, wherein the plurality of category information comprise an information corresponding to a second category, and the learning method further comprises:
extracting a feature corresponding to the information corresponding to the second category from the fused feature to generate a category embedding corresponding to the second category.

6. The semantic-related learning method according to claim 5, wherein the category information comprises an information corresponding to a third category and an information corresponding to a fourth category, and predicting at least one of the plurality of category information corresponding to the fused feature through the prediction model comprises:
determining an attention coefficient between a category embedding corresponding to the third category and a category embedding corresponding to the fourth category, wherein the attention coefficient corresponds to a correlation between the third category and the fourth category; and
updating the category embedding corresponding to the third category according to the attention coefficient.

7. The semantic-related learning method according to claim 6, wherein determining the attention coefficient between the category embedding corresponding to the third category and the category embedding corresponding to the fourth category comprises:
determining a co-occurrence probability of the two category information of the third category and the fourth category through a training dataset, wherein the co-occurrence probability is a ratio of a co-occurrence number of the two category information to an occurrence number of one of the category information;
determining an edge type according to the co-occurrence probability, wherein the edge type is for indicating a directionality corresponding to the two category information, and the directionality is that one of the two category information serves as a start node and another of the two category information serves as an end node; and
determining the attention coefficient between the third category and the fourth category according to the edge type.

8. The semantic-related learning method according to claim 7, wherein the loss information comprises a loss function, and training the prediction model according to the loss information between the predicted category information and the real information of the captured image comprises:
training the prediction model through the loss function, wherein the loss function comprises a first error and a second error, the first error is an error between the predicted category information and the real information, and the second error is an error between the attention coefficient and the co-occurrence probability.

9. The semantic-related learning method according to claim 5, wherein predicting at least one of the plurality of category information corresponding to the fused feature through the prediction model comprises:
concatenating the plurality of category embeddings corresponding to the plurality of category information; and
predicting at least one of the plurality of category information corresponding to a concatenated category embedding.

10. The semantic-related learning method according to claim 1, wherein the plurality of category information comprise an action information and an explanation information, the scene is a road, the explanation information is for describing a condition of the road presented by the captured image, and the action information is for describing a vehicle control command corresponding to the condition.

11. A semantic-related learning apparatus, comprising:
a storage, configured to store a code; and
a processor, coupled to the storage and disposed to load the code so as to:
encode a captured image to generate a feature map, wherein the captured image is an image obtained by shooting a scene;
encode a plurality of category information to generate a plurality of semantic embeddings, wherein one of the plurality of category information corresponds to a textual content;
fuse the feature map and one of the plurality of semantic embeddings to generate a fused feature;
predict at least one of the plurality of category information corresponding to the fused feature through a prediction model; and
train the prediction model according to a loss information between the predicted category information and a real information of the captured image.

12. The semantic-related learning apparatus according to claim 11, wherein the plurality of semantic embeddings comprise a first semantic embedding, and the processor is further disposed to:
fuse an image feature at each location in the feature map and the first semantic embedding to generate a fused feature corresponding to each location in the feature map and the first semantic embedding.

13. The semantic-related learning apparatus according to claim 12, wherein the processor is further disposed to:
fuse the image feature and the first semantic embedding through a tanh function.

14. The semantic-related learning apparatus according to claim 11, wherein the plurality of category information comprise an information corresponding to a first category, and the processor is further disposed to:
determine a cross attention coefficient of the fused feature, comprising:
assigning a weight corresponding to the information corresponding to the first category to the fused feature, wherein the weight is related to an attention degree of the information corresponding to the first category.

15. The semantic-related learning apparatus according to claim 11, wherein the plurality of category information comprise an information corresponding to a second category, and the processor is further disposed to:
extract a feature corresponding to the information corresponding to the second category from the fused feature to generate a category embedding corresponding to the second category.

16. The semantic-related learning apparatus according to claim 15, wherein the category information comprises an information corresponding to a third category and an information corresponding to a fourth category, and the processor is further disposed to:
determine an attention coefficient between a category embedding corresponding to the third category and a category embedding corresponding to the fourth category, wherein the attention coefficient corresponds to a correlation between the third category and the fourth category; and
update the category embedding corresponding to the third category according to the attention coefficient.

17. The semantic-related learning apparatus according to claim 16, wherein the processor is further disposed to:
determine a co-occurrence probability of the two category information of the third category and the fourth category through a training dataset, wherein the co-occurrence probability is a ratio of a co-occurrence number of the two category information to an occurrence number of one of the category information;
determine an edge type according to the co-occurrence probability, wherein the edge type is for indicating a directionality corresponding to the two category information, and the directionality is that one of the two category information serves as a start node and another of the two category information serves as an end node; and
determine the attention coefficient between the third category and the fourth category according to the edge type.

18. The semantic-related learning apparatus according to claim 17, wherein the loss information comprises a loss function, and the processor is further disposed to:
train the prediction model through the loss function, wherein the loss function comprises a first error and a second error, the first error is an error between the predicted category information and the real information, and the second error is an error between the attention coefficient and the co-occurrence probability.

19. The semantic-related learning apparatus according to claim 15, wherein the processor is further disposed to:
concatenate the plurality of category embeddings corresponding to the plurality of category information; and
predict at least one of the plurality of category information corresponding to a concatenated category embedding.

20. The semantic-related learning apparatus according to claim 11, wherein the plurality of category information comprise an action information and an explanation information, the scene is a road, the explanation information is for describing a condition of the road presented by the captured image, and the action information is for describing a vehicle control command corresponding to the condition.
